(19) United States
(12) Patent Application Publication
(10) Pub. No.: US 2016/0235047 A1
(43) Pub. Date: Aug. 18, 2016

(54) FISHING EQUIPMENT WITH BLADE BASED ATTRACTOR

(71) Applicant: Ruben Mirabal, Vancouver, WA (US)

(72) Inventor: Ruben Mirabal, Vancouver, WA (US)

(21) Appl. No.: 15/136,167

(22) Filed: Apr. 22, 2016

Related U.S. Application Data
(60) Provisional application No. 62/258,401, filed on Nov. 20, 2015.

(51) Int. Cl. A01K 85/10; A01K 85/01; A01K 91/04; A01K 85/00

(52) U.S. Cl. CPC A01K 85/10; A01K 85/005; A01K 85/01; A01K 91/04

(57) ABSTRACT

The embodiments of the present invention provide a fishing equipment with a blade based attractor. The fishing equipment comprises at-least four corner blades and a central bait wire. The at-least four corner blades are connected to a common head through at-least four wires. The central bait wire is connected to the head and lies at equidistance from each corner at a centre position. The head further is attached to the corner blades and the central bait wire through a dual snap swivel. The head is connected to a fishing rod through split ring. The head is primarily made up of resin.

### BACKGROUND

1. Technical Field of Invention

The embodiments herein generally relate to a fishing equipment and particularly relates to a blazzing blade attractor for a fishing equipment. The embodiments herein more particularly relate to a blazing blade attractor to lure increased number of fishes.

2. Description of Related Art

Fishing tackle is an equipment used by a person during fishing. Almost any equipment or gear used for fishing can be called fishing tackle. Some examples are hooks, lines, sinkers, floats, rods, reels, baits, lures, spears, nets, gaffs, traps, waders ad tackle boxes. Gear that is attached to the end of a fishing line is called terminal tackle. This includes hooks, leaders, swivels, sinkers, floats, split rings and wire, snaps, beads, spoons, blades, spinners and devises to attach spinner blades to fishing lures. Sometimes the term fishing rig is used for a completed assembly of tackle ready for fishing. During fishing, one of the most important issue is to lure the fish towards the tackle.

Out of various developments in the devices and equipments to lure the fish, one prior art discloses a multi-section hollow sound chamber containing a plurality of beads and including bore holes or a tubular mounting bore, which is isolated from the sound chamber, for supporting the chamber from a fishing line, wire-form or lure. Associated buoyancy and rotation means facilitate auditory sounds. In various constructions, the chamber parts mount in mated and bonded relation about a hook shank, a wire-form coupling member or a fishing line. Included fins or external grooves facilitate chamber rotation with movement relative to water.

Another prior art discloses a trolling attractor comprising an elongated spinner shaft, a spinning blade supported on the shaft for rotation about the axis thereof, a bowed resilient guard, means connecting the opposite ends of the guard to said spinner shaft including yieldable means, said yieldable means normally holding the guard out of the path of rotation of the spinning blade and which under tension thereof moves the guard into intersection with the path of rotation of the spinning blade, for the purpose set forth.

However, the prior art fishing equipment limits a focus on a bit and hook assembly and follow conventional way of fishing which is highly time consuming and less productive.

In the view of the foregoing, there is a need for a fishing equipment with an enhanced attractor for luring a large number of fishes in short time span. Further there is a need for a fishing equipment with ability to capture fishes of various sizes.

The above mentioned shortcomings, disadvantages and problems are addressed herein, as detailed below.

### SUMMARY OF THE INVENTION

The primary objective of the present invention is to provide a fishing equipment with an enhanced attractor for luring a large number of fishes in short time span.

Another object of the present invention is to provide a fishing equipment with ability to capture fishes of various sizes.

The various embodiments of the present invention provide a fishing equipment with a blade based attractor. The fishing equipment comprises at-least four corner blades and a central bait wire. The at-least four corner blades are connected to a common head through at-least four wires. The central bait wire is connected to the head and lies at equidistance from each corner at a centre position. The head further is attached to the corner blades and the central bait wire through a dual snap swivel. The head is connected to a fishing rod through split ring. The head is primarily made up of resin.

According to one embodiment herein, the central bait wire comprises a hook connected to the head through a ball bearing swivel with a horizontal degree of freedom of movement ranging from 0-359°.

According to one embodiment herein, the at-least four corner blades are made up of a willow blade spinner.

According to one embodiment herein, the at-least four corner blades open in an angular form in a direction away from the central bait wire. The diameter of a luring area formed by the opening of the at-least four corner blades is upto 11.0 inches.

According to one embodiment herein, the diameter of the luring area is increased and decreased by pulling and releasing the at-least four wires respectively.

According to one embodiment herein, the split ring performs a rattling function against the at-least four corner blades and a central bait wire to lure a fish.

According to one embodiment herein, the at-least four corner blades and the central bait wire are connected to each through a roller swivel.

According to one embodiment herein, the at-least four corner blades trolls a fish with a speed range of 1-4.5 mph.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIGS. 1A and 1B illustrates an expanded view and a contracted view of a fishing equipment with a blade based attractor, respectively, according to each embodiment herein.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments of the present invention provide a fishing equipment with a blade based attractor. The fishing equipment comprises at-least four corner blades and a central bait wire. The at-least four corner blades are connected to a common head through at-least four wires. The central bait wire is connected to the head and lies at equidistance from each corner at a centre position. The head further is attached to the corner blades and the central bait wire through a dual snap swivel. The head is connected to a fishing rod through split ring. The head is primarily made up of resin.

According to one embodiment herein, the central bait wire comprises a hook connected to the head through a ball bearing swivel with a horizontal degree of freedom of movement ranging from 0-359°.

According to one embodiment herein, the at-last four corner blades are made up of a willow blade spinner.

According to one embodiment herein, the at-least four corner blades open in an angular form in a direction away from the central bait wire. The diameter of a luring area formed by the opening of the at-least four corner blades is upto 11.0 inches.

According to one embodiment herein, the diameter of the luring area is increased and decreased by pulling and releasing the at-least four wires respectively.

According to one embodiment herein, the split ring performs a rattling function against the at-least four corner blades and a central bait wire to lure a fish.

According to one embodiment herein, the at-least four corner blades and the central bait wire are connected to each through a roller swivel.

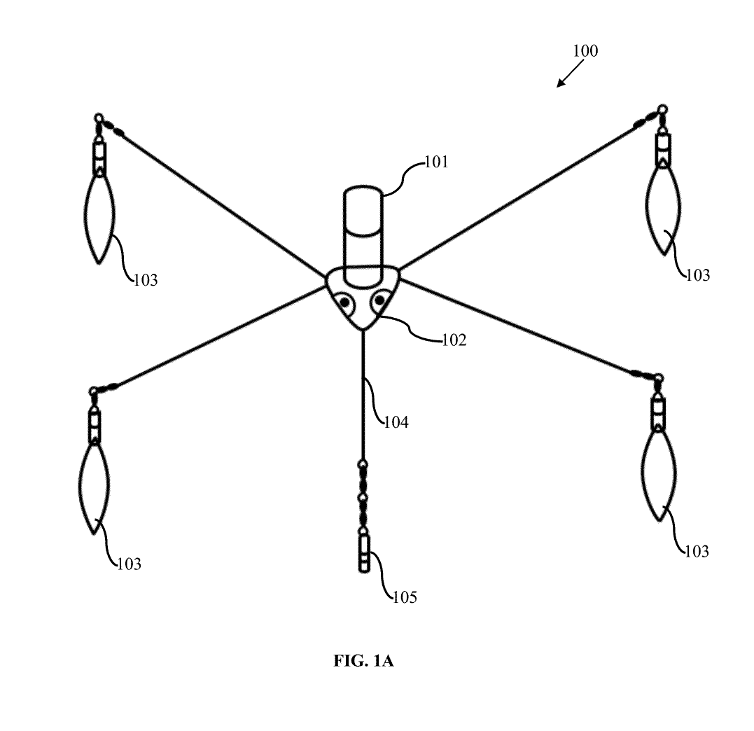

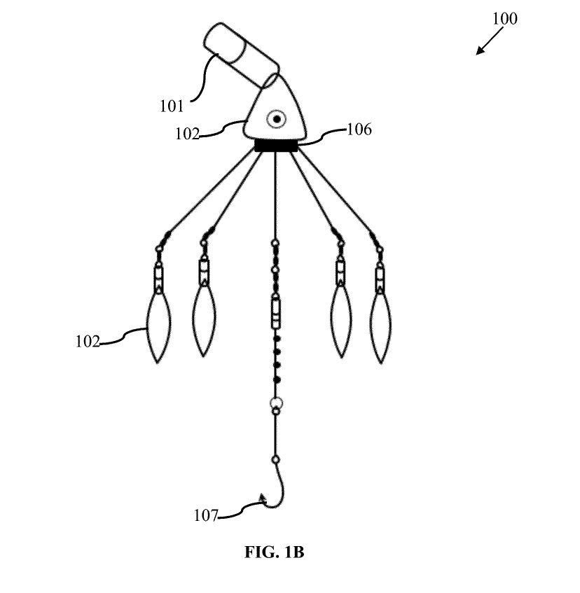

FIGS. 1A and 1B illustrates an expanded view and a contracted view of a fishing equipment with a blade based attractor, respectively, according to each embodiment herein. With respect to FIGS. 1A and 1B, the blade based attractor is connected to a fishing rod of the fishing equipment. The blade based attractor 100 comprises a head 102 connected to the fishing rod through a dual snap swivel 101. The head 102 is connected to the at-least four corner blades 103 through the at-least four wires having a length of 5.5 inches. Each wire connects at-least one corner blade 103 with the head through a split ring rattler 106. The split ring rattler 106 lures the fish toward the fishing equipment by making a rattling vibration. A central bait wire 104 having a length of 5.75 inches is connected to the split ring rattler 106. The central bait wire 104 comprises a hook 107 and a bait holder of user's selection. Each wire of the at-least four corner blades and the central bait wire is made up of stainless steel with a diameter of 0.041 inches. The central bait wire 104 comprises a ball bearing swivel 105 to hold the hook 107.

According to one embodiment herein, the at-least four corner blades are same or differently coloured, so a user has clarity of sight under water. The colour of the at-least four corner blades is also selected according a colour of water to match a water condition in which fishing is intended.

The head is made up of resin thus reducing the weight of the fishing equipment and providing an ease in movement. The light weight fishing equipment maintain a depth in a water column even during a trolling at different speeds. A diameter of a luring area in the present fishing equipment is dynamically adjusted by the contracting or expanding a gap between the at-least four corner blades and the central bait wire. Thus a user feels an ease of fishing different sizes of fish with single fishing equipment.

The fishing equipment is enhanced to be attached to an anchor under adequate water flow conditions.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A fishing equipment with a blade based attractor comprises:
at-least four corner blades, wherein the at-least four corner blades are connected to a common head through at-least four wires;
a central bait wire, wherein the central bait wire is connected to the head and lies at equidistance from each corner at a centre position;
wherein, the head further is attached to the corner blades and the central bait wire through a dual snap swivel, wherein the head is connected to a fishing rod through split ring.

2. The fishing equipment according to claim 1, wherein the head is primarily made up of resin.

3. The fishing equipment according to claim 1, wherein the central bait wire comprises a hook connected to the head through a ball bearing swivel with a horizontal degree of freedom of movement ranging from 0-359°.

4. The fishing equipment according to claim 1, wherein the at-last four corner blades are made up of a willow blade spinner.

5. The fishing equipment according to claim 1, wherein the at-least four corner blades open in an angular form in a direction away from the central bait wire, wherein the diameter of a luring area formed by the opening of the at-least four corner blades is upto 11.0 inches.

6. The fishing equipment according to claim 5, wherein the diameter of the luring area is increased and decreased by pulling and releasing the at-least four wires respectively.

7. The fishing equipment according to claim 1, wherein the split ring performs a rattling function against the at-least four corner blades and a central bait wire to lure a fish.

8. The fishing equipment according to claim 1, wherein the at-least four corner blades and the central bait wire are connected to each through a roller swivel.

9. The fishing equipment according to claim 1, wherein the at-least four corner blades trolls a fish with a speed range of 1-4.5 mph.
